(19) United States
(12) Patent Application Publication
(10) Pub. No.: US 2014/0102129 A1
(43) Pub. Date: Apr. 17, 2014

(54) Mixing Method and Cooling Mixer

(71) Applicants: Klaus Reisner, Dortmund (DE); Joachim Himler, Lippetal (DE); Christian Honemeyer, Detmold (DE); Ulrich Schär, Horn-Bad Meinberg (DE); Burkhard Wulf, Brakel (DE); Thomas Tegtmeier, Horn-Bad Meinberg (DE)

(72) Inventors: Klaus Reisner, Dortmund (DE); Joachim Himler, Lippetal (DE); Christian Honemeyer, Detmold (DE); Ulrich Schär, Horn-Bad Meinberg (DE); Burkhard Wulf, Brakel (DE); Thomas Tegtmeier, Horn-Bad Meinberg (DE)

(73) Assignees: REISNER AG, Holzwickede (DE); MTI MISCHTECHNIK INTERNATIONAL GMBH, Detmold (DE)

(21) Appl. No.: 13/880,437

(22) PCT Filed: Oct. 19, 2011
(86) PCT No.: PCT/EP2011/005264

§ 371 Date: Nov. 20, 2013

(30) Foreign Application Priority Data
Oct. 19, 2010 (DE) 10 2010 048 697.3

(51) Int. Cl. B01F 15/06

(52) U.S. Cl. CPC B01F 15/065
USPC 62/448; 366/149

(57) ABSTRACT

A mixing process for mixed material, in particular bulk material with simultaneous cooling of the mixed material in a double-walled mixing vessel where a coolant is circulated in the space between the external walls, whereby the coolant is formed by the refrigerant in a refrigerator which is released from high pressure in the space between the external walls and which evaporates and extracts temperature from the mixed material.

### BACKGROUND OF THE INVENTION

The invention relates to a mixing process for mixed material, in particular bulk material, with simultaneous cooling of the mixed goods having a double-walled mixing vessel where a coolant is circulated in the space between the external walls.

Mixing processes with simultaneous cooling of the mixed goods are known in various forms. The cooling of the mixed goods is in particular required during the mixing process if certain temperature-dependent reactions or changes in the properties of the mixed goods are of particular relevance. Therefore, there are specific cooling mixers comprising a mixing vessel which has a double-walled external shell. A space is formed between the double walls of the external shell in which a cooling medium or a heating medium, for example in the form of oil, cold or hot water, steam, brine or other water-based media, is circulated.

Due to the temperature control, i.e. the cooling or heating of the mixed material, chemical reactions or physical modifications can be caused under certain circumstances. Cooling is always advantageous if the mixed material requires a certain temperature for the further processing or delivery of the mixed goods.

### SUMMARY OF THE INVENTION

The invention is based on the task of creating a mixer and a mixing process allowing for the mixed goods to be cooled during the mixing.

In order to solve this task, the mixing process according to the invention is characterised in that the refrigerant of a refrigerator is evaporated in the space between the two external walls. The refrigerant is released from high pressure in the space and evaporates and extracts temperature from the mixed material as heat of vaporisation.

This cooling and mixing process is very efficient since the cooling allowed by the refrigerating unit is effected directly in the mixer without heat exchangers having to be interposed via a secondary circuit, as is normally the case. The interposing of heat exchangers results in unnecessary loss of energy and thus in a reduction of the efficiency of the cooling system.

The double-walled cooling vessel is preferably formed with an outer wall with a small distance to the inner vessel wall which allows for the circulation of a cooling medium and can also be used as evaporator within the meaning of the present invention.

The task of the invention in view of its apparatus features is solved by a cooling mixer comprising a double-walled mixing vessel characterised in that the mixing vessel is integrated into a refrigerator and that the space between the external walls of the mixing vessel forms the evaporator of the refrigerator.

The jacket of the double-walled vessel forms spaces serving as chamber for the vaporisation process of the refrigerator in their entirety.

The vessel wall including the end plates can be subdivided into several areas which can be cooled separately or with different degrees of intensity. Therefore, it is possible to increase the cooling effect in certain areas of the vessel and reduce it in others.

### BRIEF DESCRIPTION OF THE DRAWINGS

In the following, preferred embodiments are explained in more detail on the basis of the enclosed drawings.

FIG. 1 is a side view of a mixer according to the invention with a horizontally positioned mixing vessel and a horizontal drive shaft;

FIG. 2 is a side view of FIG. 1 from the left side in FIG. 1;

FIG. 3 is a schematic flow diagram for illustrating the cooling process and the interaction with the mixer according to the invention.

### DETAILED DESCRIPTION

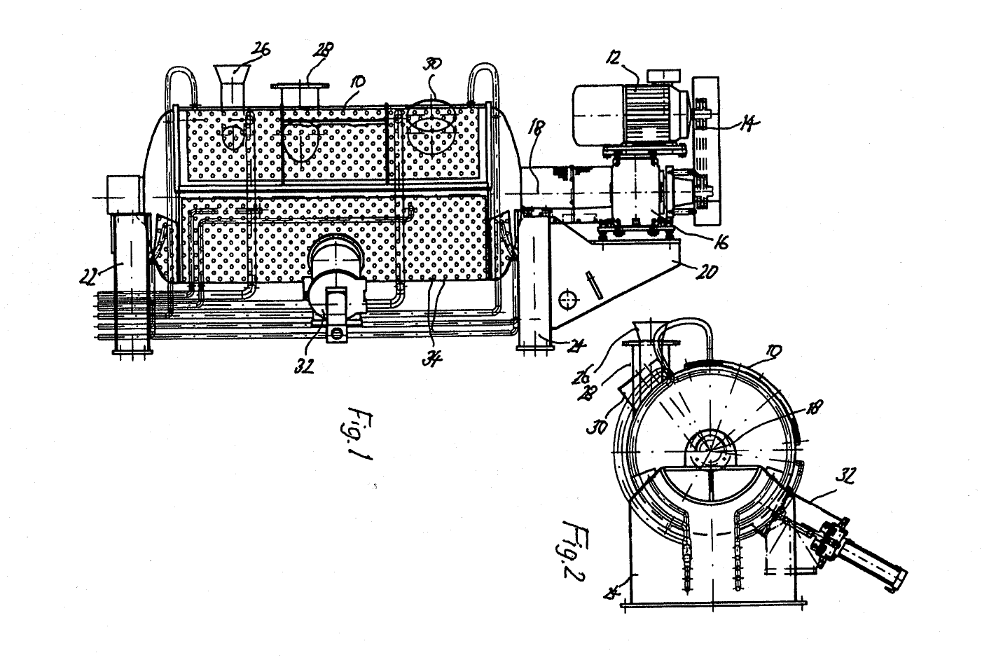

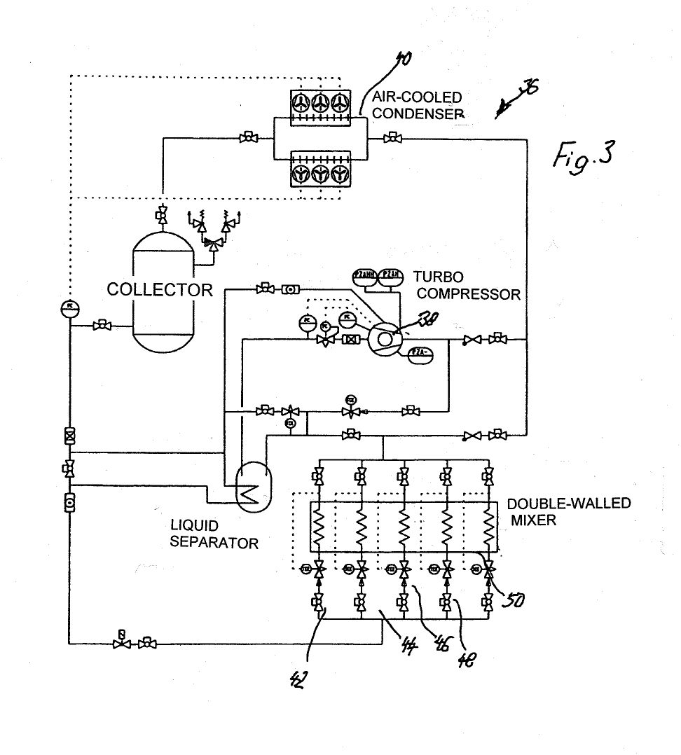

In FIG. 1, a horizontal, cylindrical vessel 10 is shown which is driven by an electric motor 12 situated on the right-hand side of the drawing. The electric motor 12 is connected to a gearbox 16 via a plurality of V-belts 14. A shaft 18, which is not shown but only characterised by means of a dashed and dotted line, is driven by said gearbox. There is a mixing tool (also not visible) on the shaft by means of which the mixed material is circulated. It is also possible that several mixing tools are situated on the shaft. This technology is commonly used so that no details have to be explained. The electric motor and the gearbox are positioned on a support structure 20 situated at the right-hand side of the mixing vessel 10 with respect of FIG. 1. The efficiency of the mixing tools can be increased by means of laterally installed choppers rotating at high speed.

The mixing vessel 10 is supported by bearing blocks 22, 24 at both axial ends. The support structure 20 is situated at the right bearing block 24.

In the upper area of the mixing vessel 10, several material inlet sockets 26, 28, 30 are situated. In the lower area, a lateral outlet 32 is provided.

As shown best in FIG. 3, at the outside of the inner vessel wall 60 which is in contact with the product, there is an external wall 62 which is attached with a defined small distance 64 therebetween. Guide plates in the space 64 generate a directed flow of the cooling medium. Each segment of the double wall forms a coherent cavity which can be used as vaporisation chamber within the meaning of the evaporator of the refrigerator.

The cooling wall structure can be subdivided into individual areas. Therefore, it is possible to increase or reduce the cooling within the mixing vessel in certain areas.

As already explained above, the refrigerator 36 has a compressor, a condenser 40 and an evaporator formed by five individual areas or chambers 42, 44, 46, 48, 50. During the release of the refrigerant from high pressure, heat is withdrawn from the environment, i.e. the cooling mixer which is normal for cooling processes. After the vaporisation process, the refrigerant is gaseous. In the individual chambers 42, 44, 46, 48, 50, the release process can be controlled by means of relief valves not further defined so that it is possible to regulate the cooling effect in the individual chambers separately.

The subdivision of the individual chambers and their positioning can be effected in different ways. Among other things, it is possible to treat the areas of the two vessel side plates at the axial ends of the vessel separately.

The five chambers shown in the illustrated example also form an evaporator in their entirety which forms part of the cooling process according to the invention.

Since the vaporisation procedure of the cooling process takes place in the space between the double vessel walls, the mixed material is cooled directly. No heat exchanger is required since such heat exchanger would only make the construction of the cooling mixer more complex and increase the constructional effort.

What is claimed is:

1. Mixing process for bulk mixed material, comprising the steps of:
mixing the bulk material in a double-walled mixing vessel, and
simultaneous cooling of the mixed material in the double-walled mixing vessel, by circulating a coolant in a space between two external walls of the mixing vessel with a coolant formed by refrigerant of a refrigerator which is released from high pressure in the space between the external walls and which evaporates and extracts temperature from the mixed material.

2. Mixing process according to claim 1, further comprising the steps of:
dividing a stream of the refrigerant into several partial streams on a high-pressure side and
evaporating the stream of refrigerant in partial streams between the external walls of the mixing vessel.

3. Cooling mixer comprising a double-walled mixing vessel having external walls with a space between the external walls in which a coolant circulates and a mixing tool in the mixing vessel, wherein the mixing vessel is integrated into a refrigerator and the space between the external walls of the mixing vessel forms an evaporator of a refrigerator.

4. Cooling mixer according to claim 3, wherein the space between the external walls of the mixing vessel is subdivided into several areas and the areas in their entirety form the evaporator of the refrigerator.
